(19) United States
(12) Patent Application Publication
(10) Pub. No.: US 2026/0065492 A1
(43) Pub. Date: Mar. 5, 2026

(54) SMART GLASSES AND IMAGE PROCESSING METHOD THEREFOR

(71) Applicant: Alipay (Hangzhou) Information Technology Co., Ltd., Hangzhou (CN)

(72) Inventors: Xiujing LIN, Hangzhou (CN); He WANG, Hangzhou (CN); Tinghe DING, Hangzhou (CN); Jingyi LOU, Hangzhou (CN)

(21) Appl. No.: 19/308,238

(22) Filed: Aug. 24, 2025

(30) Foreign Application Priority Data
Sep. 2, 2024 (CN) 202411223344.9

(51) Int. Cl. G06T 7/246; G06F 3/01; G06T 3/40; G06T 7/11; G06T 7/73; H04N 23/20

(52) U.S. Cl. CPC G06T 7/246; G06F 3/013; G06T 3/40; G06T 7/11; G06T 7/73; G06T 2207/10048; G06T 2207/30196; H04N 23/20

(57) ABSTRACT

This specification provides smart glasses and an image processing method therefor. The smart glasses include an eye tracking apparatus, a first camera, and a processor. When detecting that an eye movement type is non-saccade, the processor determines a target area image corresponding to a fixation point based on eye tracking, performs downsampling on a first image captured by the first camera to obtain a second image, and sends the second image and the target area image to a mobile terminal. Through interaction between the smart glasses and the mobile terminal and with reference to eye tracking, AI recognition and an intelligent suggestion are implemented for an object on which a user fixates. Furthermore, a manner of combining a high-definition local image with a low-definition panoramic image is implemented. In addition, full references are made to context background information of the recognized object.

### TECHNICAL FIELD

One or more embodiments of this specification relate to the field of wearable device technologies, and in particular, to smart glasses and an image processing method therefor.

### BACKGROUND

As intelligent requirements of users for wearable devices increase, smart glasses are no longer limited to conventional functions such as physiological parameter detection, music play, calls, and recording. High-definition cameras are integrated into some smart glasses, to implement intelligent image recognition and detection, for example, artificial intelligence (AI) object recognition, AI assistants, and other functions.

In a related technology, the smart glasses have limited computing power, resulting in a relatively long image processing time, noticeable perception of a waiting process by the user, and poor functional experience.

### SUMMARY

In view of this, implementations of this specification provide smart glasses, an image processing method and apparatus therefor, a storage medium, and a computer program product.

According to a first aspect, some implementations of this specification provide smart glasses, including:
an eye tracking apparatus, configured to capture a fixation point of a user eye;
a first camera, configured to capture a first image, where the first image represents a scene image in a field of view of a user; and
a processor, configured to: in response to detecting that an eye movement type of the user is non-saccade, segment the first image based on the fixation point to obtain a target area image, perform downsampling processing on the first image to obtain a second image, send the target area image and the second image to a mobile terminal, and receive an image processing result sent by the mobile terminal.

In some implementations, the eye tracking apparatus includes a light source component and an infrared camera, the light source component is configured to emit an infrared light source toward the user eye, the infrared camera is configured to capture a spot image of the user eye, and the spot image includes a spot formed on the user eye by the infrared light source emitted by the light source component; and

the processor is configured to: perform image detection on the spot image to determine a relative location between a pupil center of the user eye and the spot, and determine the fixation point of the user eye based on the relative location and a pre-calibrated spot location.

In some implementations, the infrared camera is further configured to capture an eye movement parameter of the user eye, where the eye movement parameter represents an eye movement speed of the user eye; and

the processor is configured to: receive the eye movement parameter captured by the infrared camera, and determine the eye movement type of the user eye based on the eye movement parameter.

In some implementations, the smart glasses include a body, the body includes a lens frame and temples connected to two sides of the lens frame, and the lens frame includes an inner sidewall facing the user eye and an outer sidewall facing away from the user eye; and

the eye tracking apparatus is disposed on the inner sidewall of the lens frame, and the first camera is disposed on the outer sidewall of the lens frame.

In some implementations, the smart glasses further include a speaker, the processor is configured to generate a voice instruction based on the image processing result, and the speaker is configured to play the voice instruction.

In some implementations, the smart glasses further include a display apparatus, and the display apparatus is configured to display the image processing result.

According to a second aspect, an implementation of this specification provides an image processing method, applied to smart glasses. The method includes:
in response to detecting that an eye movement type of a user is non-saccade, obtaining a first image in a field of view of the user and a fixation point of a user eye;
determining a target area on the first image based on the fixation point, and segmenting the target area to obtain a target area image;
performing downsampling processing on the first image to obtain a second image; and
sending the target area image and the second image to a mobile terminal bound and connected to the smart glasses, and receiving an image processing result sent by the mobile terminal.

In some implementations, the eye movement type includes saccade and non-saccade, and a process of detecting the eye movement type of the user includes:
capturing an eye movement parameter of the user eye through an eye tracking apparatus, where the eye movement parameter represents an eye movement speed of the user eye; and
when the eye movement parameter is greater than or equal to a preset threshold, determining that the eye movement type is saccade; or
when the eye movement parameter is less than a preset threshold, determining that the eye movement type is non-saccade.

In some implementations, a process of obtaining the fixation point of the user eye includes:
emitting an infrared light source to the user eye through a light source component of an eye tracking apparatus, and obtaining a spot image of the user eye captured by an infrared camera of the eye tracking apparatus, where the spot image includes a spot formed on the user eye by the infrared light source emitted by the light source component;
performing image detection on the spot image to determine a relative location between a pupil center of the user eye and the spot; and
determining the fixation point of the user eye based on the relative location and a pre-calibrated spot location.

In some implementations, the determining a target area on the first image based on the fixation point, and segmenting the target area to obtain a target area image includes:
determining an image location of the fixation point on the first image based on a pre-calibrated mapping relationship, where the mapping relationship represents a mapping relationship between a coordinate system in which the fixation point is located and an image coordinate system of the first image;
performing image detection on the first image, and determining an image area that includes the image location at which the fixation point is located as the target area; and
performing image segmentation on the target area to obtain the target area image.

In some implementations, after the receiving an image processing result sent by the mobile terminal, the method further includes:
generating a voice instruction based on the image processing result, and playing the voice instruction;
and/or
displaying the image processing result on a display apparatus of the smart glasses.

According to a third aspect, an implementation of this specification provides an image processing apparatus, applied to smart glasses. The apparatus includes:
an image obtaining module, configured to: in response to detecting that an eye movement type of a user is non-saccade, obtain a first image in a field of view of the user and a fixation point of a user eye;
an image segmentation module, configured to: determine a target area on the first image based on the fixation point, and segment the target area to obtain a target area image;
a downsampling module, configured to perform downsampling processing on the first image to obtain a second image; and
a data communication module, configured to: send the target area image and the second image to a mobile terminal bound and connected to the smart glasses, and receive an image processing result sent by the mobile terminal.

In some implementations, the eye movement type includes saccade and non-saccade, and the image obtaining module is configured to:
capture an eye movement parameter of the user eye through an eye tracking apparatus, where the eye movement parameter represents an eye movement speed of the user eye; and
when the eye movement parameter is greater than or equal to a preset threshold, determine that the eye movement type is saccade; or
when the eye movement parameter is less than a preset threshold, determine that the eye movement type is non-saccade.

In some implementations, the image obtaining module is configured to:
emit an infrared light source to the user eye through a light source component of an eye tracking apparatus, and obtain a spot image of the user eye captured by an infrared camera of the eye tracking apparatus, where the spot image includes a spot formed on the user eye by the infrared light source emitted by the light source component;
perform image detection on the spot image to determine a relative location between a pupil center of the user eye and the spot; and
determine the fixation point of the user eye based on the relative location and a pre-calibrated spot location.

In some implementations, the image segmentation module is configured to:
determine an image location of the fixation point on the first image based on a pre-calibrated mapping relationship, where the mapping relationship represents a mapping relationship between a coordinate system in which the fixation point is located and an image coordinate system of the first image;
perform image detection on the first image, and determine an image area that includes the image location at which the fixation point is located as the target area; and
perform image segmentation on the target area to obtain the target area image.

According to a fourth aspect, an implementation of this specification provides a storage medium, storing computer instructions. The computer instructions are used to enable a computer to perform the method in any one of the above-mentioned implementations.

According to a fifth aspect, an implementation of this specification provides a computer program product. When the computer program product is executed by a computer, the method in any one of the above-mentioned implementations is implemented.

The smart glasses in the implementations of this specification include an eye tracking apparatus, a first camera, and a processor. When detecting that an eye movement type is non-saccade, the processor determines a target area image corresponding to a fixation point based on eye tracking, performs downsampling on a first image captured by the first camera to obtain a second image, and sends the second image and the target area image to a mobile terminal. Through interaction between the smart glasses and the mobile terminal and with reference to eye tracking, AI recognition and an intelligent suggestion are implemented for an object on which a user fixates, thereby enriching intelligent requirements for the smart glasses. Furthermore, in a manner of combining a high-definition local image with a low-definition panoramic image, an amount of communication data between the smart glasses and the mobile terminal is reduced, a transmission rate between the smart glasses and the mobile terminal is increased, and a waiting time of the user is shortened. In addition, full references are made to context background information of the recognized object, to improve accuracy of an AI task, meet requirements of more tasks, and achieve a balance between transmission efficiency and a task effect.

### BRIEF DESCRIPTION OF DRAWINGS

FIG. 1 is a schematic diagram of smart glasses according to an example implementation of this specification;

FIG. 2 is a schematic diagram of interaction between smart glasses, a mobile terminal, and a cloud server according to an example implementation of this specification;

FIG. 3 is a structural block diagram of smart glasses according to an example implementation of this specification;

FIG. 4 is a flowchart of an image processing method according to an example implementation of this specification;

FIG. 5 is a flowchart of an image processing method according to an example implementation of this specification;

FIG. 6 is a flowchart of an image processing method according to an example implementation of this specification;

FIG. 7 is a schematic diagram of an image processing method according to an example implementation of this specification;

FIG. 8 is a schematic diagram of an image processing method according to an example implementation of this specification;

FIG. 9 is a flowchart of an image processing method according to an example implementation of this specification;

FIG. 10 is a schematic diagram of an image processing method according to an example implementation of this specification; and

FIG. 11 is a structural block diagram of an image processing apparatus according to an example implementation of this specification.

### DESCRIPTION OF EMBODIMENTS

User information (including but not limited to user equipment information, personal user information, etc.) and data (including but not limited to data used for analysis, stored data, displayed data, etc.) in this specification are information and data that are authorized by a user or that are fully authorized by each party. Furthermore, related data needs to be collected, used, and processed in compliance with relevant laws, regulations and standards of relevant countries and regions, and corresponding operation entries are provided for the user to choose to authorize or reject.

With development of smart wearable devices, various smart glasses products have emerged. Currently, the smart glasses products can be mainly classified into two types. One type of products is mainly oriented to head-mounted entertainment scenarios such as augmented reality (AR)/virtual reality (VR). This type of products is usually large in volume, has relatively high computing power performance, and is suitable for short-term use in gaming and entertainment. The other type of products mainly implements functions such as health detection, music play, and call making/answering. This type of products needs to meet daily wear requirements of users, and needs to have an appearance, a volume, and a weight the same as those of common glasses. Computing power performance of the device is limited.

Nowadays, users have increasingly high intelligent requirements for smart glasses, and are no longer satisfied with conventional functions such as physiological parameter (for example, heart rate, oxygen saturation, and blood pressure) detection, music play, calls, and recording. Therefore, artificial intelligence (AI) functions are integrated into some smart glasses, to implement AI object recognition, AI assistants, and other functions.

In a daily life scenario, a user often needs to recognize an object, for example, recognize a name of a flower or plant, a breed of a pet, instructions for a drug, or a caloric content of food. Currently, some requirements can be met on a mobile terminal. For example, a smartphone is used as an example. The user can enable a camera application (app) on the mobile phone, enable an AI object recognition function, and align a viewfinder of the mobile phone with a to-be-recognized object, so that object information, for example, a name of a flower or plant or a breed of a pet, can be displayed in the viewfinder. Alternatively, the user can capture an image by using a camera, and recognize object information on the captured image through AI object recognition.

In the above-mentioned mobile terminal scenario, the user needs to actively use the mobile terminal to capture an image of a to-be-recognized object. An operation process is complex and cumbersome. If the above-mentioned function can be transplanted into the smart glasses, the user only needs to normally fixate on an object, and the smart glasses can recognize object information and notify the user by using a voice or a display screen. This greatly simplifies a user operation and frees up hands of the user.

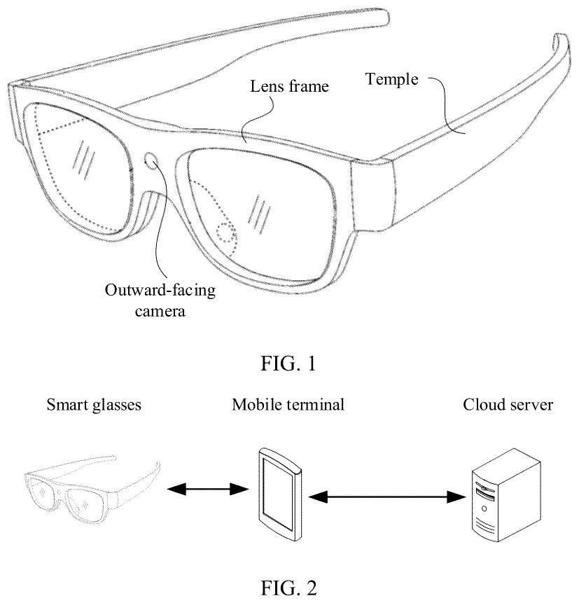

For example, in an example in FIG. 1, an outward-facing camera can be disposed on the smart glasses. A function of the outward-facing camera is to capture an environment image in a field of view of a user. For example, when the user sees a flower and expects to know a name of the flower and related information, the smart glasses can capture a scene image through the outward-facing camera, then obtain related information of the flower by using an image processing algorithm and with reference to a neural network model, and feed back a result to the user through voice or text display. For another example, some users have a sugar control requirement. When the user purchases a fruit and expects to know a sugar content of each fruit to direct the user to purchase a proper fruit, the smart glasses can capture a fruit image through the outward-facing camera, and then obtain sugar content information of one or more fruits by using an image processing algorithm and with reference to a neural network model.

In the above-mentioned example scenario, compared with a conventional mobile terminal, the smart glasses greatly facilitate a user operation. Because the smart glasses are directly worn on a user head and move with the user head, an image in the field of view of the user can always be captured, and the user does not need to manually adjust an angle and capture an image. This frees up hands of the user and improves operation convenience.

However, to implement the AI function, a corresponding AI model needs to be inevitably used. The AI model is a neural network model used in the artificial intelligence field. The AI model is obtained through training by using a large amount of data, and has powerful performance in tasks such as natural language processing (NLP) and computer vision (CV). A parameter quantity and a volume of the AI model are very large. For example, a

parameter quantity of a generative large model can reach a level of 100 million or a level of trillion. The smart glasses and the mobile terminal have limited performance, and the model cannot be deployed locally. The AI model is usually deployed on a cloud server. For example, as shown in FIG. 2, the smart glasses can establish a binding relationship for a communication connection with the mobile terminal through near field communication. The near field communication manner can include, for example, Bluetooth or Wi-Fi. The mobile terminal establishes a communication connection to the cloud server through a wide area network. The wide area network is, for example, a cellular network. During implementation of the above-mentioned AI function, the smart glasses need to upload a captured image to the mobile terminal, and then the mobile terminal sends the image to the cloud server. The cloud server processes the image, and then delivers a result to the mobile terminal, and the mobile terminal sends the result to the smart glasses.

For an image processing task, clarity of an image is a basis for ensuring task accuracy. In addition, as the user pursues a high-definition image, the outward-facing camera of the smart glasses is usually a high-definition camera, the captured scene image is a high-definition image, and an image volume is relatively large. Therefore, when the smart glasses and the mobile terminal perform image transmission, a transmission process is relatively slow. Consequently, an entire service procedure is slowed down, and the user can noticeably perceive a waiting time, resulting in poor actual experience.

In addition, in an actual scenario, in addition to an object of interest to the user, the captured image may include another object. For example, in an example, the user stands in front of a fruit stall and expects to know only a sugar content of a watermelon. However, an image captured by the smart glasses may further include another fruit. After the image is sent to the cloud server, the AI model needs to perform feature extraction and processing on all fruits on the image. This undoubtedly results in an increase in computational burden and slows down a service procedure. However, if an area of interest of the user is obtained through segmentation from the image before the model is entered, and only the area of interest is sent to the model, because a background image is missing, context information of a to-be-recognized object is lost, and accuracy of an output result is poor in some task scenarios.

Therefore, it can be learned that in a related technology, image transmission efficiency between the smart glasses and the mobile terminal is relatively low, and image processing for the area of interest of the user is relatively poor, resulting in a poor AI service effect of the smart glasses. Based on this, implementations of this specification provide smart glasses, an image processing method and apparatus for the smart glasses, a storage medium, and a computer program product.

In some implementations, this specification provides smart glasses. The smart glasses include a body and various electrical components disposed on the body.

For example, with reference to FIG. 1, the body of the smart glasses includes a lens frame and temples connected to two sides of the lens frame. The lens frame is a carrier frame used to assemble a transparent lens. The lens can be selected and configured by a user based on a requirement of the user, making it suitable for daily wear by different users. This is not limited in this specification. The temple can be connected to the lens frame through a hinge, so that the temple can be folded or unfolded. In this implementation of this specification, the electrical component can be disposed inside the lens frame and the temple.

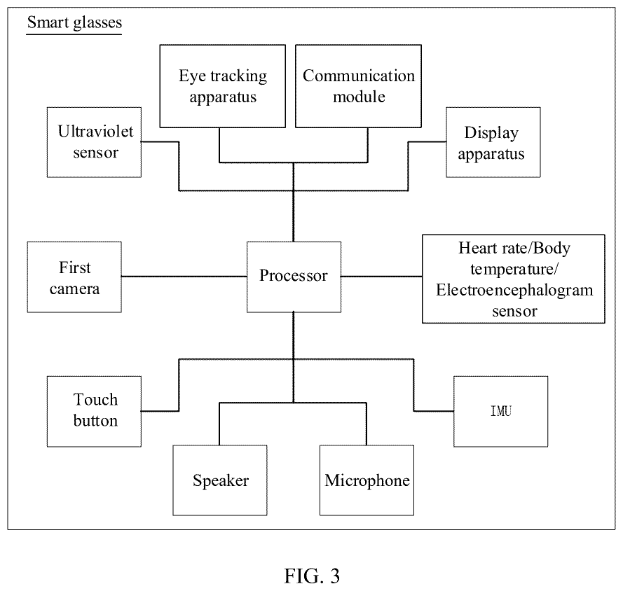

FIG. 3 is a structural block diagram of smart glasses according to some implementations of this specification. The following describes an electrical component and a structure of the smart glasses with reference to FIG. 3.

With reference to FIG. 3, the smart glasses include a processor, a first camera, an eye tracking apparatus, a communication module, an ultraviolet sensor, a display apparatus, a speaker, a microphone, an IMU sensor, a heart rate/body temperature/electroencephalogram sensor, a touch button, etc.

The processor can include one or more processing units. For example, the processor can include an application processor (AP), a modem processor, a graphics processing unit (GPU), an image signal processor (ISP), a video processing unit (VPU) controller, a memory, a video codec, a digital signal processor (DSP), a baseband processor, and/or a neural-network processing unit (NPU). Different processing units can be independent components, or can be integrated into one or more processors. In some implementations, the processor can alternatively be a microcontroller unit (MCU).

A memory can be further disposed in the processor, and is configured to store instructions and data. In some implementations, the memory in the processor is a cache. The memory can store instructions or data just used or cyclically used by the processor. If the processor needs to use the instructions or the data again, the processor can directly invoke the instructions or the data from the memory. This avoids repeated access and shortens a waiting time of the processor, thereby improving system efficiency.

In some implementations, the processor can be disposed on a main board, and the main board is disposed inside a temple of the smart glasses.

The first camera is an apparatus disposed on the smart glasses to implement image capture. The first camera can include an optical lens module. The optical lens module includes one or more lenses combined along an optical axis, and can further include a photosensitive element, for example, a complementary metal oxide semiconductor (CMOS) sensor, or can further include an image signal processing (ISP) chip, etc.

In this implementation of this specification, the first camera can capture a scene image in a field of view of a user. For example, in an example, with reference to FIG. 1, the first camera can be an outward-facing camera of the smart glasses, that is, the first camera is disposed on an outer sidewall that is of a lens frame and that faces the outside, so that the first camera can capture an external environment image. It can be understood that after the user wears the smart glasses, the field of view of the user extends beyond the lens toward the outside. Therefore, the environment image captured by the first camera is a scene image in the field of view of the user.

The eye tracking apparatus is configured to track movement of a user eye, to determine a fixation point of the human eye. For example, a pupil location can be located by using an image processing technology, and coordinates of a pupil center can be obtained, to calculate the fixation point of the human eye. In the following image processing method in this specification, an algorithm process of determining the fixation point through eye tracking is described.

In this implementation of this disclosure, the eye tracking apparatus can be disposed on an inner sidewall of the lens frame, and the eye tracking apparatus faces the user eye, so that an image of the user eye can be captured to implement eye tracking. It should be noted that the eye tracking apparatus can be disposed near only one eye, or the eye tracking apparatus can be disposed near each of two eyes. This is not limited in this specification.

In some implementations, the eye tracking apparatus includes a light source component and an infrared camera. The light source component includes one or more infrared emitters, and a function of the infrared emitter is to emit infrared light toward the human eye. Because the infrared light is invisible to the human eye, an infrared light source does not affect the human eye, and eye tracking without perception by the user can be implemented. The infrared emitter emits an infrared light source toward the human eye. After irradiating the human eye, the infrared light source is reflected in an area such as a cornea or an iris of the human eye. The infrared camera can capture an image of reflected light and a human eye image, to obtain a spot image including the human eye. The spot image includes the image of the reflected light (namely, a spot) and the human eye image. An optical axis direction of a pupil can be determined based on the spot image, to obtain a line of sight direction of the user and determine the fixation point.

In some implementations, the infrared camera can further capture an eye movement parameter of the user eye. The eye movement parameter represents an eye movement speed of the user eye. For example, in an example, the eye movement parameter can include an eye movement speed parameter, an acceleration parameter, etc. of an eyeball of the user. By using the eye movement parameter, the processor can determine an eye movement type of the user, that is, whether the user is currently in a fixation state. This is described in the following implementations of this specification.

The ultraviolet sensor is a device for converting an ultraviolet signal into an electrical signal. In some implementations of this specification, the ultraviolet sensor can be disposed on the outer sidewall of the lens frame, so that ultraviolet intensity of an external environment can be detected through the ultraviolet sensor. The processor can remind the user of sun protection or notify the user of an ultraviolet level, etc. based on the ultraviolet intensity detected by the ultraviolet sensor, to prevent the user from being exposed to a strong ultraviolet environment for a long time.

The communication module is a related circuit module for performing data exchange between the smart glasses and an external electronic device. In this implementation of this specification, the communication module can be a wired communication module, or can be a wireless communication module. The wired communication module is used as an example. The wired communication module can include a data interface. The data interface can be, for example, a universal serial bus (USB) interface, a micro USB interface, a type-C interface, etc. A wired communication connection to another electronic device can be implemented by plugging and unplugging a data cable and the data interface. The wireless communication module is used as an example. The wireless communication module can include a Bluetooth module, a Wi-Fi module, a corresponding antenna structure, etc. A wireless communication connection to another electronic device can be established through the wireless communication module. For example, in the example shown in FIG. 2, the smart glasses can establish a wireless communication connection to the mobile terminal through the wireless communication module.

In some implementations, the communication module can be disposed on a main board, and the main board is disposed inside the temple.

The display apparatus is configured to present an image to the user under control of the processor. In some implementations, the display apparatus can be a projection apparatus disposed on the temple. In this way, the projection apparatus can project and display, on the lens, an image signal sent by the processor, and the user can see the displayed image on the lens. In some other implementations, the display apparatus can be a transparent display screen that serves as a lens. In this way, an image signal is directly displayed on the lens, and the user can see the displayed image on the lens. It can be understood that there are many types of display apparatuses for displaying the image on the lens, and the above-mentioned example constitutes no limitation.

The heart rate/body temperature/electroencephalogram sensor is an electronic component used to detect a physiological parameter of the user. For example, the heart rate sensor is used as an example. The heart rate sensor can be disposed on the temple, and a detection end is disposed on an inner sidewall of the temple. In this way, after the user wears the smart glasses, a skin behind an ear can be in close contact with the detection end of the heart rate sensor, to implement heart rate detection. Body temperature and electroencephalogram detection can be performed in a similar manner.

The inertial measurement unit (IMU) sensor is an apparatus for detecting a three-axis posture and acceleration of a device. The IMU sensor can include an accelerometer and a gyroscope. When a head posture of the user changes, the smart glasses move with the head, the IMU sensor can detect posture and acceleration parameters of the smart glasses, and the processor can calculate the posture of the device in real time based on the posture and acceleration parameters.

In some implementations, when the user wears the smart glasses in a still state, a posture change detected through the IMU sensor can reflect a heart rate and a respiration state of the user, to detect physiological parameters such as the heart rate and respiration of the user.

The speaker and the microphone are configured to implement an audio function of the smart glasses, for example, music play and recording. The speaker is also referred to as a “horn”, and is configured to convert an audio electrical signal into a sound signal. The smart glasses can listen to music or answer a call through the speaker. The microphone is also referred to as a “mike” or a “mic”, and is configured to convert a sound signal into an electrical signal. The smart glasses can implement sound capture, voice conversation, etc. through the microphone.

In this implementation of this specification, a plurality of speakers and a plurality of microphones can be disposed on the smart glasses, and the plurality of speakers or the plurality of microphones can implement a same function or different functions. For example, in an example, one speaker can be disposed at a location at which each temple is close to a back of the ear of the user, and two speakers form a stereo speaker, to provide higher listening experience to the user. The microphone can alternatively include a microphone array disposed at a plurality of locations of the smart glasses, and a user voice and ambient noise are separately captured through the microphone array, to implement call noise reduction.

The touch button is an interactive button between the user and the smart glasses. The touch button can be buttons in various forms, for example, a physical button or a pressure-sensitive button. The touch button can implement various functions, for example, adjusting volume, controlling music play/pause, switching to a previous song/next song, answering/hanging up a call, and enabling/disabling an eye tracking function. In some implementations, the touch button can be disposed at any location of the smart glasses, provided that the user can operate the touch button. For example, in an example, the touch button is disposed on the temple.

In some implementations, the smart glasses can further include a second camera (not shown in the accompanying drawings). The second camera can be disposed on the inner sidewall of the lens frame, or can be disposed at a connection location between the lens frame and the temple. The second camera faces the human eye. A function of the second camera is to capture an eye image, and an emotion of the user can be recognized based on the eye image.

Some electrical components included in the smart glasses are described above. It can be understood that the electrical components of the smart glasses are not limited to the above-mentioned example, and more or fewer components can be further included. For example, on the above-mentioned basis, the smart glasses can further include a battery, a light-emitting diode (LED), etc. Details are not described in this disclosure.

In some implementations, this specification provides an image processing method. The method can be applied to the smart glasses in any one of the above-mentioned implementations, and is performed by a processor of the smart glasses. The following describes a method process with reference to FIG. 4.

As shown in FIG. 4, in some implementations, the image processing method shown as an example in this specification includes the following steps.

S410: In response to detecting that an eye movement type of a user is non-saccade, obtain a first image in a field of view of the user and a fixation point of a user eye.

The eye movement type is a type of a human eye activity. In this implementation of this specification, a movement speed of the human eye is used to represent the eye movement type, and the eye movement type can be classified into saccade and non-saccade. Saccade means that an eyeball quickly moves and a line of sight direction quickly moves in a short time. For example, in a state in which the user quickly glances at an environment, the eyeball quickly moves to observe a surrounding environment. In this case, the eyeball moves at a very high speed, and a corresponding eye movement type is saccade. In contrast, non-saccade indicates that the human eyeball moves at a very low speed or is still. For example, when the user fixates on an object, the line of sight direction of the eyeball is fixed, and the eyeball is in a still state. For another example, when the user slowly moves a line of sight direction in a book reading process, the eyeball moves at a very low speed, and an eye movement type in which the line of sight direction is still or slowly moves is non-saccade.

In some implementations, non-saccade can be further classified into two types: fixation and smooth movement. Fixation indicates that the human eyeball is in the still state and the line of sight direction remains unchanged. Smooth movement indicates that the human eyeball moves at a low speed and the line of sight direction slowly moves. Certainly, it can be understood that the eye movement type can include only two types: saccade and non-saccade.

In this implementation of this specification, the smart glasses can detect the eye movement type of the eyeball of the user in real time. If the eye movement type is saccade, it indicates that the user does not fixate on an object, and does not need to recognize an object. In this case, the image processing method in this specification does not need to be started. On the contrary, if it is detected that the eye movement type is non-saccade, it indicates that the user is currently fixating on an object, and the user needs to recognize the object. Therefore, the method steps in the image processing method in this specification can be started.

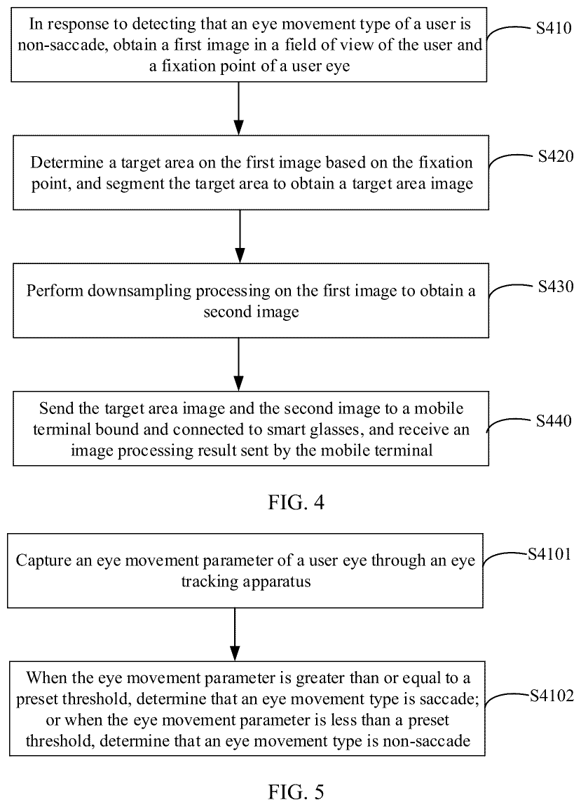

In some implementations, an eye movement speed of the user can be recognized through an eye tracking apparatus, and it is determined, based on the eye movement speed, whether the eye movement type is non-saccade. The following provides descriptions with reference to FIG. 5.

As shown in FIG. 5, in some implementations, a process of detecting the eye movement type of the user by using the image processing method shown as an example in this specification includes the following steps.

S4101: Capture an eye movement parameter of the user eye through the eye tracking apparatus.

S4102: When the eye movement parameter is greater than or equal to a preset threshold, determine that the eye movement type is saccade; or when the eye movement parameter is less than a preset threshold, determine that the eye movement type is non-saccade.

In this implementation of this specification, the eye movement parameter is a related parameter used to represent the eye movement speed of the user, for example, can be an eye movement speed parameter, an eye movement acceleration parameter, etc. The eye movement speed parameter is used as an example, and the eye movement speed can be represented by movement displacement of a pupil center of the eyeball per unit time.

With reference to the above-mentioned descriptions, it can be learned that the eye tracking apparatus includes an infrared camera. An eye image of the user can be captured through the infrared camera, pupil center point coordinates of the user can be recognized through image detection, and the eye movement speed parameter can be calculated based on a change in the pupil center point coordinates per unit time.

In this implementation of this specification, a corresponding threshold or threshold range can be preset for the eye movement speed parameter, and an interval of the eye movement type is delimited by using the threshold range. For example, in an example, the threshold range of the eye movement speed can be shown in Table 1 below:

TABLE 1

| Eye movement speed parameter | Eye movement type |
|---|---|
| ≥Th1 | Saccade |
| <Th1 | Non-saccade |

In the example in Table 1, if the detected eye movement speed parameter is greater than or equal to the preset threshold Th1, it indicates that the current eye movement speed is very high. In this case, it can be determined that the eye movement type of the eyeball is saccade. On the contrary, if the detected eye movement speed parameter is less than the preset threshold Th1, it indicates that the current eye movement speed is relatively low. In this case, it can be determined that the eye movement type of the eyeball is non-saccade.

In the example in Table 1, only “saccade” and “non-saccade” are used as examples for the eye movement type. With reference to the above-mentioned descriptions, it can be learned that in another implementation, the eye movement type can be further subdivided into three types: “saccade”, “smooth movement”, and “fixation”. In addition, a threshold range can be allocated to each of the three eye movement types in advance. For example, in an example, the threshold range of the eye movement speed can be shown in Table 2 below:

TABLE 2

| Eye movement speed parameter | Eye movement type |
|---|---|
| ≥Th1 | Saccade |
| (Th1, Th2] | Smooth movement |
| <Th2 | Fixation |

In the example in Table 2, if the detected eye movement speed parameter is greater than or equal to the preset threshold Th1, it indicates that the current eye movement speed is very high. In this case, it can be determined that the eye movement type of the eyeball is saccade. If it is detected that the eye movement speed parameter is greater than the preset threshold Th1 and less than or equal to the preset threshold Th2, it indicates that the eye movement speed of the eyeball is relatively low and it is in a slow movement state. In this case, it can be determined that the eye movement type is smooth movement. If it is detected that the eye movement speed parameter is less than the preset threshold Th2, it indicates that the current eye movement speed of the eyeball is very low, and it can be considered that the user is currently in a fixation state. In this case, it can be determined that the eye movement type of the eyeball is fixation.

It can be understood by a person skilled in the art that in the above-mentioned example, the method in this specification can be performed when it is determined that the eye movement type is non-saccade based on the example in Table 1, or the method in this specification can be performed when it is determined that the eye movement type is fixation based on the example in Table 2. This is not limited.

When it is determined that the eye movement type of the user is non-saccade, it indicates that the user needs to recognize an object in an actual scenario. In this case, the above-mentioned first camera can be invoked to capture the first image. With reference to FIG. 1, the first camera is an outward-facing camera that is disposed on the smart glasses and that faces the outside. In this way, the first image captured by the first camera is an image in the field of view of the user.

It can be understood that when the user expects to recognize an object, the user usually fixates on the object, so that the object appears in the field of view of the user. In this case, the first image captured through the first camera is an image that includes the to-be-recognized object. However, in an actual scenario, in addition to the to-be-recognized object, the first image captured by the first camera usually includes many other background or environment information. To accurately recognize the to-be-recognized object to which the user pays attention, references can be made to the fixation point of the user eye, and an object to which the fixation point points is the to-be-recognized object.

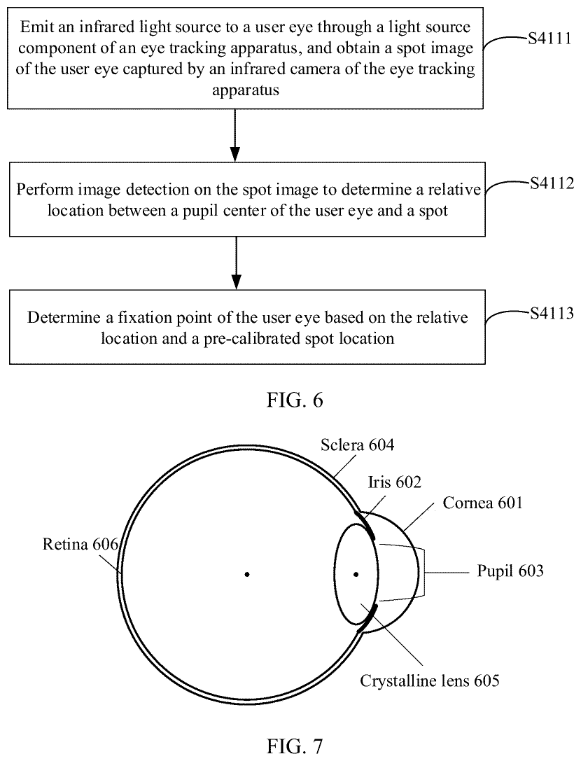

Therefore, in this implementation of this specification, when the first image is captured, the fixation point of the user eye further needs to be recognized through the eye tracking apparatus. The following provides descriptions with reference to an implementation in FIG. 6.

As shown in FIG. 6, in some implementations, a process of determining the fixation point of the user eye by using the image processing method shown as an example in this specification includes the following steps.

S4111: Emit an infrared light source to the user eye through a light source component of the eye tracking apparatus, and obtain a spot image of the user eye captured by the infrared camera of the eye tracking apparatus.

S4112: Perform image detection on the spot image to determine a relative location between a pupil center of the user eye and a spot.

S4113: Determine the fixation point of the user eye based on the relative location and a pre-calibrated spot location.

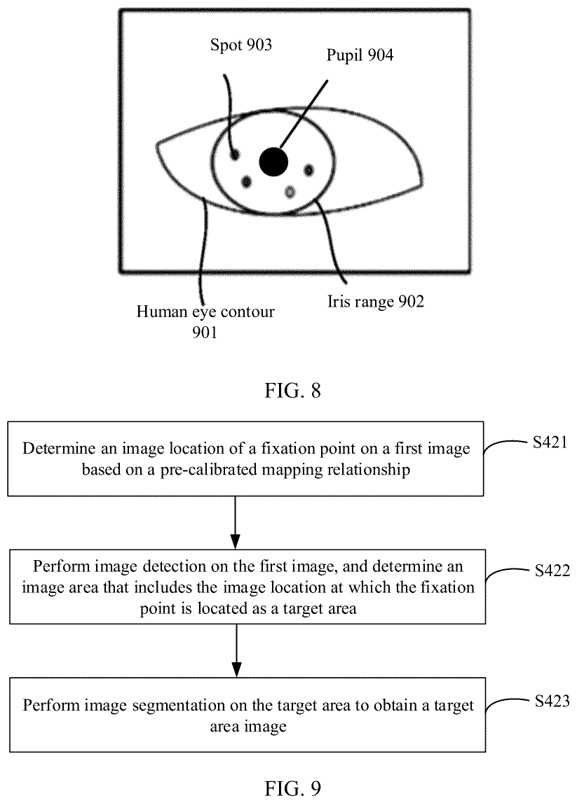

For ease of understanding, the following describes a working principle of the eye tracking apparatus with reference to FIG. 7 and FIG. 8.

FIG. 7 shows a cross-sectional structure of a human eyeball. With reference to FIG. 7, the eyeball includes a cornea 601, an iris 602, a pupil 603, a sclera 604, a crystalline lens 605, and a retina 606. The cornea 601 has relatively high reflectivity to light irradiated by a light source, and therefore a relatively clear reflection point can be formed after irradiation by the light source. The cornea 601 is a transparent front part of the eyeball, and is a first pass through which light enters the eyeball. Approximately 3 mm of a center of an outer surface of the cornea 601 is a spherical curved surface, which is referred to as an optical zone. A peripheral curvature radius gradually increases, and is in an aspherical shape. In the eyeball structure model shown in FIG. 7, the cornea 601 is assumed to be a spherical curved surface.

The iris 602 covered by the cornea 601 is a disc-shaped membrane and located in a dark circular area, and there is a hole referred to as the pupil 603 in the center. The pupil 603 is a small round hole in an iris center of an animal or a human eye, and is a passage through which light enters the eye. A center point of the pupil 603 is a viewpoint. The crystalline lens 605 is a biconvex transparent tissue, is located behind the iris 602, has a shape and a function similar to those of a convex lens, and can clearly reflect images of a nearby object and a distant object on the retina 606. The retina 606 is a photosensitive part of the eyeball, and an external object is imaged on the retina 606. The scleral 604 (also referred to as the white of the eye) has relatively low reflectivity to light irradiated by a light source. The scleral 604 is one of main components of an eyeball wall, is located at a junction with the cornea, has a tough structure, and has a function of supporting and protecting an intraocular tissue.

When detecting the fixation point, the eye tracking apparatus can emit an infrared light source to the human eye through the light source component. After irradiating the human eye, the infrared light source is reflected in an area such as the cornea or the iris of the human eye. The infrared camera can capture an eye image of the user. The eye image includes a human eye image and an image of reflected light. The image of the reflected light forms a spot on the human eye, and therefore becomes a spot image.

For example, in an example, the spot image captured by the infrared camera can be shown in FIG. 8. A spot 903 is an image generated by the infrared light source on the eyeball in a corneal or iris range, and a human eye contour 901, an iris range 902, and a pupil 904 are the human eye image. Certainly, it can be understood that the spot image further includes other tissues and parts of the user eye, for example, eyelids and eyelashes, which are not shown in this specification.

In this implementation of this specification, after obtaining the spot image, the processor can perform image detection on the spot image to determine location information of the pupil center and each spot. For example, in the example in FIG. 8, image detection is performed on the spot image to determine center point coordinates of the pupil 904 and coordinates of each spot. After the center point coordinates of the pupil 904 and the coordinates of the spot are determined, the relative location between the pupil center and the spot can be obtained.

When the eye tracking apparatus is assembled on the smart glasses, the eye tracking apparatus can be calibrated. An objective of calibration is to establish a mapping relationship between a spot location on an image and a location in a world coordinate system, that is, the pre-calibrated spot location is a spot location corresponding to a real world. Therefore, after the relative location between the pupil center and the spot is detected, location information of the pupil center in the world coordinate system can be determined based on the pre-calibrated spot location, and the location information is the fixation point of the user eye.

S420: Determine a target area on the first image based on the fixation point, and segment the target area to obtain a target area image.

In S410, the first image that includes the to-be-recognized object is captured through the first camera, and the fixation point of the user eye is detected through the eye tracking apparatus. Then, an area in which the to-be-recognized object is located can be determined from the first image based on the fixation point of the user eye. The following provides descriptions with reference to FIG. 9.

As shown in FIG. 9, in some implementations, a process of determining and obtaining the target area image through segmentation by using the image processing method shown as an example in this specification includes the following steps.

S421: Determine an image location of the fixation point on the first image based on a pre-calibrated mapping relationship.

S422: Perform image detection on the first image, and determine an image area that includes the image location at which the fixation point is located as the target area.

S423: Perform image segmentation on the target area to obtain the target area image.

In this implementation of this specification, the target area is a local area on the first image. The area includes an object on which the user fixates, that is, includes the to-be-recognized object. An objective of image segmentation is to obtain an image area of the to-be-recognized object through segmentation from the first image.

First, image coordinates corresponding to the fixation point on the first image need to be determined. For example, a mapping relationship between an image coordinate system of the first image and the world coordinate system can be pre-calibrated, and then spatial transformation is performed on coordinates of the fixation point by using the mapping relationship, to convert the coordinates of the fixation point into the image coordinate system, so as to determine the image coordinates of the fixation point on the first image.

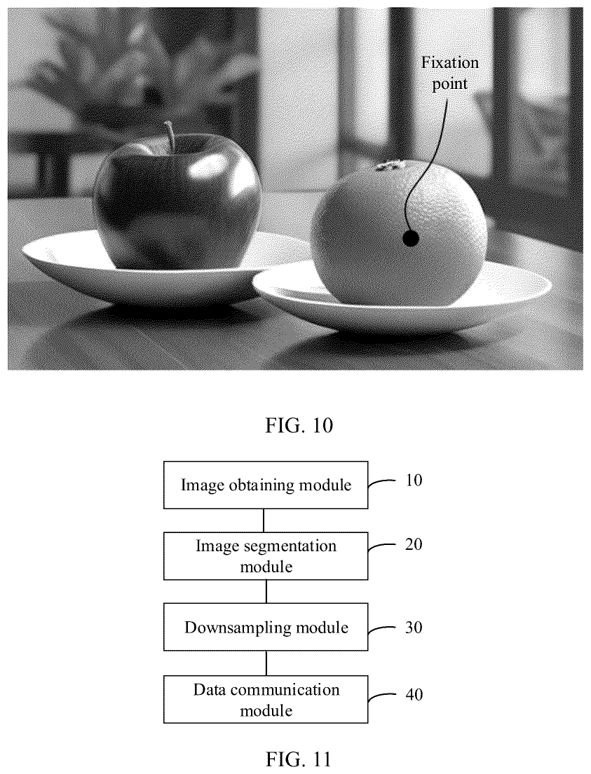

For example, in an example, the captured first image can be shown in FIG. 10, and the first image includes two types of fruits: an apple and an orange. Through the above-mentioned image detection process, it is determined that the image location of the fixation point on the first image is shown in FIG. 10, which indicates that the user fixates on the orange.

Then, an object on the image needs to be detected based on the image location of the fixation point, to determine the target area in which the fixation point is located. FIG. 10 is still used as an example. The processor can perform edge feature extraction on the first image. There are many algorithms for edge feature extraction, including but not limited to a Sobel algorithm, a Canny algorithm, etc. This is not limited in this disclosure. An objective of edge feature extraction is to determine each object included on the first image. For example, in the example in FIG. 10, after edge feature extraction is performed, an image edge of an object such as the apple, the orange, a plate, a table, and a background on the first image can be obtained, and image content can be divided into a plurality of areas by using the image edge. Finally, with reference to the image location at which the fixation point is located, an image area in which the “orange” is located is determined as the target area.

After the target area is determined, image segmentation can be performed on the target area to obtain a target area image that includes only the “orange”.

S430: Perform downsampling processing on the first image to obtain a second image.

It should be noted that in this implementation of this specification, after the target area image is obtained through segmentation, not only the target area image is sent to a mobile terminal. This is because in the image processing field, an environment and background information around the object also include rich semantic features. In some image processing tasks, an image detection task can be better assisted with reference to context information of a background area. In this way, accuracy of the image processing task can be improved, and more task types can be implemented.

For example, in an example, it is assumed that in the above-mentioned image segmentation process, the target area image obtained through segmentation is a blank area that has no actual significance. If only the target area image is sent to a backend model, the model cannot accurately recognize a user intent. In an actual scenario, rich image content may be included around the target area image. If references can be made to a panoramic image, the model can more accurately recognize an object and a user intent.

For example, in another example, the first image shown in FIG. 10 is used as an example. In a service scenario, although the user fixates on the orange, the user may expect to know a sugar content of each fruit. If only an orange area on which the user fixates is obtained through segmentation as the target area image and sent to the backend model, the model can obtain only a sugar content result of the orange and feed back the result to the user, but cannot make intelligent recommendation for another fruit.

Based on this, in this implementation of this specification, in addition to sending the target area image to the backend model, the panoramic image needs to be sent to the backend model. However, with reference to the above-mentioned descriptions, it can be learned that the panoramic image has relatively high definition and a relatively large data amount. Consequently, a transmission speed between the smart glasses and the mobile terminal is relatively low, resulting in a long waiting time of the user.

Therefore, in this implementation of this specification, in a manner of combining a high-definition local image with a low-definition panoramic image, an image area of interest to the user and the panoramic image can be sent to the backend model. In addition, in a manner of reducing resolution of the panoramic image, an amount of transmitted data is reduced, thereby improving AI service efficiency and reducing waiting duration of the user.

Specifically, in some implementations, after the target area image is obtained through segmentation, the processor can perform downsampling processing on the first image to obtain the second image. Image downsampling is a process of reducing image resolution. A downsampling manner can include, for example, pixel deletion and pixel resampling. Pixel resampling is used as an example. An interpolation algorithm can be used to calculate n neighboring pixels as one pixel, thereby greatly reducing a data amount. An image obtained after downsampling is the second image.

S440: Send the target area image and the second image to the mobile terminal bound and connected to the smart glasses, and receive an image processing result sent by the mobile terminal.

Based on the above-mentioned descriptions, it can be learned that in this implementation of this specification, the high-definition target area image and the low-definition second image obtained after downsampling are sent to the mobile terminal together. With reference to FIG. 2, when the mobile terminal has sufficient computing power, image processing can be performed based on the target area image and the second image by using an AI model deployed on the mobile terminal, to obtain a corresponding image processing result and return the result to the smart glasses. When the mobile terminal has insufficient computing power, the mobile terminal can forward the target area image and the second image to a cloud server, and an AI model deployed on the cloud server performs image processing based on the target area image and the second image, to obtain a corresponding image processing result and return the result to the smart glasses.

It can be understood that the target area image is an object on which the user fixates, and the object is an object to which the user pays attention on the first image. Therefore, the target area image of the object is a high-definition image, to ensure recognition accuracy of the object. In addition, the second image is a panoramic image, and is used as background information to assist an image processing task. Therefore, resolution of the panoramic image is reduced through downsampling, to reduce an amount of transmitted data, increase a transmission rate between the smart glasses and the mobile terminal, and shorten a waiting time of the user.

In other words, in this implementation of this specification, compared with a solution in which the first image is directly sent, this can effectively reduce a data amount, improve transmission efficiency between the smart glasses and the mobile terminal, and improve user experience. In addition, compared with a solution in which only the target area image obtained through segmentation is sent, full references can be made to context background information of the recognized object, to improve accuracy of an AI task and meet a requirement of an AI task that requires full image information. In this implementation of this specification, a balance is achieved between transmission efficiency and a task effect.

It should be noted that specific function implementation is not limited in this implementation of this specification. The solution in this specification can be applied to any image processing-based service scenario. The following uses several service scenarios as examples for description.

### 1. Dietary Health Management

The smart glasses can capture a first image that includes food such as a dish, a fruit, and a cake, then obtain, through segmentation based on the above-mentioned image processing method, a target area image of food on which the user fixates, perform downsampling on the original first image to obtain a second image, and then send the second image and the target area image of the food to the mobile terminal.

The mobile terminal forwards the second image and the target area image to the cloud server. The cloud server invokes the AI model, and jointly sends the second image and the target area image as inputs to the AI model. The AI model outputs, through image detection, heat (for example, a calorie value), a nutrition component (for example, a sugar content), a dish name, a hot cooking method, etc. corresponding to the food as an image processing result.

The cloud server delivers the image processing result to the mobile terminal, and the mobile terminal forwards the image processing result to the smart glasses, so that the user can obtain information such as the heat, the nutrition component, the cooking method, and the dish name of the food at a smart glasses end. Specific information included in the image processing result can be freely selected by the user. The user presets required result information on the mobile terminal, to display only the image processing result information set by the user.

### 2. Medication Guidance

The smart glasses can capture a first image that includes a drug name (for example, a drug box and a drug packaging bag), then obtain, through segmentation based on the above-mentioned image processing method, a target area image of a drug on which the user fixates, perform downsampling on the original first image to obtain a second image, and then send the second image and the target area image of the drug to the mobile terminal.

The mobile terminal forwards the second image and the target area image to the cloud server. The cloud server invokes the AI model, and jointly sends the second image and the target area image as inputs to the AI model. The AI model outputs, through image detection, instructions for use, medication guidance, precautions, etc. corresponding to the drug, or can further provide a health suggestion.

The cloud server delivers the information as an image processing result to the mobile terminal, and the mobile terminal forwards the image processing result to the smart glasses, so that the user can obtain information such as the instructions for use, the medication guidance, the precautions, and the health suggestion at a smart glasses end. Specific information included in the image processing result can be freely selected by the user. The user presets required result information on the mobile terminal, to display only the image processing result information set by the user.

### 3. Emotional Guidance

The smart glasses can capture an eye image of the user through the infrared camera of the eye tracking apparatus, and directly send the eye image to the mobile terminal. The mobile terminal forwards the eye image to the cloud server. The cloud server invokes the AI model to recognize an emotion of the user, and outputs a corresponding emotion guidance solution as an image processing result when the user is depressed or tired. The cloud server delivers the image processing result to the mobile terminal, and the mobile terminal forwards the image processing result to the smart glasses, so that the user can obtain a corresponding emotion guidance result at a smart glasses end.

In addition to the image processing task in the above-mentioned example, the smart glasses can further implement other functions such as physiological parameter detection, voice question answering, ultraviolet reminder, music play, and call making/answering. A person skilled in the art can undoubtedly understand and fully implement the functions based on the above-mentioned implementation. Details are not described in this specification.

In some implementations, at the smart glasses end, after receiving the image processing result sent by the mobile terminal, the smart glasses can directly play the image processing result through a speaker, so that the user can hear corresponding audio information. In some other implementations, the smart glasses can display the image processing result on a display apparatus, so that the user can see corresponding image information.

It can be learned from the above-mentioned descriptions that in this implementation of this specification, through interaction between the smart glasses and the mobile terminal and with reference to eye tracking, AI recognition and an intelligent suggestion can be implemented for an object on which a user fixates, thereby enriching intelligent requirements for the smart glasses. Furthermore, in a manner of combining a high-definition local image with a low-definition panoramic image, an amount of communication data between the smart glasses and the mobile terminal is reduced, a transmission rate between the smart glasses and the mobile terminal is increased, and a waiting time of the user is shortened. In addition, full references are made to context background information of the recognized object, to improve accuracy of an AI task, meet requirements of more tasks, and achieve a balance between transmission efficiency and a task effect.

In some implementations, this specification provides an image processing apparatus. The apparatus can be applied to the above-mentioned smart glasses. As shown in FIG. 11, the apparatus includes:
an image obtaining module 10, configured to: in response to detecting that an eye movement type of a user is non-saccade, obtain a first image in a field of view of the user and a fixation point of a user eye;
an image segmentation module 20, configured to: determine a target area on the first image based on the fixation point, and segment the target area to obtain a target area image;
a downsampling module 30, configured to perform downsampling processing on the first image to obtain a second image; and
a data communication module 40, configured to: send the target area image and the second image to a mobile terminal bound and connected to the smart glasses, and receive an image processing result sent by the mobile terminal.

In some implementations, the eye movement type includes saccade and non-saccade, and the image obtaining module 10 is configured to:
capture an eye movement parameter of the user eye through an eye tracking apparatus, where the eye movement parameter represents an eye movement speed of the user eye; and
when the eye movement parameter is greater than or equal to a preset threshold,
determine that the eye movement type is saccade; or
when the eye movement parameter is less than a preset threshold, determine that the eye movement type is non-saccade.

In some implementations, the image obtaining module 10 is configured to:
emit an infrared light source to the user eye through a light source component of an eye tracking apparatus, and obtain a spot image of the user eye captured by an infrared camera of the eye tracking apparatus, where the spot image includes a spot formed on the user eye by the infrared light source emitted by the light source component;
perform image detection on the spot image to determine a relative location between a pupil center of the user eye and the spot; and
determine the fixation point of the user eye based on the relative location and a pre-calibrated spot location.

In some implementations, the image segmentation module 20 is configured to:
determine an image location of the fixation point on the first image based on a pre-calibrated mapping relationship, where the mapping relationship represents a mapping relationship between a coordinate system in which the fixation point is located and an image coordinate system of the first image;
perform image detection on the first image, and determine an image area that includes the image location at which the fixation point is located as the target area; and
perform image segmentation on the target area to obtain the target area image.

In some implementations, this specification provides a storage medium, storing computer instructions. The computer instructions are used to enable a computer to perform the method in any one of the above-mentioned implementations.

In some implementations, this specification provides a computer program product. When the computer program product is executed by a computer, the method in any one of the above-mentioned implementations is implemented.

1. Smart glasses, comprising:
an eye tracking apparatus, configured to capture a fixation point of a user eye;
a first camera, configured to capture a first image, wherein the first image represents a scene image in a field of view of a user; and
a processor, configured to: in response to detecting that an eye movement type of the user is non-saccade, segment the first image based on the fixation point to obtain a target area image, perform downsampling processing on the first image to obtain a second image, send the target area image and the second image to a mobile terminal, and receive an image processing result sent by the mobile terminal.

2. The smart glasses according to claim 1, wherein
the eye tracking apparatus comprises a light source component and an infrared camera, the light source component is configured to emit an infrared light source toward the user eye, the infrared camera is configured to capture a spot image of the user eye, and the spot image comprises a spot formed on the user eye by the infrared light source emitted by the light source component; and
the processor is configured to: perform image detection on the spot image to determine a relative location between a pupil center of the user eye and the spot, and determine the fixation point of the user eye based on the relative location and a pre-calibrated spot location.

3. The smart glasses according to claim 2, wherein
the infrared camera is further configured to capture an eye movement parameter of the user eye, wherein the eye movement parameter represents an eye movement speed of the user eye; and
the processor is configured to: receive the eye movement parameter captured by the infrared camera, and determine the eye movement type of the user eye based on the eye movement parameter.

4. The smart glasses according to claim 1, wherein
the smart glasses comprise a body, the body comprises a lens frame and temples connected to two sides of the lens frame, and the lens frame comprises an inner sidewall facing the user eye and an outer sidewall facing away from the user eye; and
the eye tracking apparatus is disposed on the inner sidewall of the lens frame, and the first camera is disposed on the outer sidewall of the lens frame.

5. The smart glasses according to claim 1, wherein
a speaker is further comprised, the processor is configured to generate a voice instruction based on the image processing result, and the speaker is configured to play the voice instruction;
and/or
a display apparatus is further comprised, and the display apparatus is configured to display the image processing result.

6. An image processing method, applied to smart glasses, wherein the method comprises:
in response to detecting that an eye movement type of a user is non-saccade, obtaining a first image in a field of view of the user and a fixation point of a user eye;
determining a target area on the first image based on the fixation point, and segmenting the target area to obtain a target area image;
performing downsampling processing on the first image to obtain a second image; and
sending the target area image and the second image to a mobile terminal bound and connected to the smart glasses, and receiving an image processing result sent by the mobile terminal.

7. The method according to claim 6, wherein the eye movement type comprises saccade and non-saccade, and a process of detecting the eye movement type of the user comprises:
capturing an eye movement parameter of the user eye through an eye tracking apparatus, wherein the eye movement parameter represents an eye movement speed of the user eye; and
when the eye movement parameter is greater than or equal to a preset threshold, determining that the eye movement type is saccade; or
when the eye movement parameter is less than a preset threshold, determining that the eye movement type is non-saccade.

8. The method according to claim 6, wherein a process of obtaining the fixation point of the user eye comprises:
emitting an infrared light source to the user eye through a light source component of an eye tracking apparatus, and obtaining a spot image of the user eye captured by an infrared camera of the eye tracking apparatus, wherein the spot image comprises a spot formed on the user eye by the infrared light source emitted by the light source component;
performing image detection on the spot image to determine a relative location between a pupil center of the user eye and the spot; and
determining the fixation point of the user eye based on the relative location and a pre-calibrated spot location.

9. The method according to claim 6, wherein the determining a target area on the first image based on the fixation point, and segmenting the target area to obtain a target area image comprises:
determining an image location of the fixation point on the first image based on a pre-calibrated mapping relationship, wherein the mapping relationship represents a mapping relationship between a coordinate system in which the fixation point is located and an image coordinate system of the first image;
performing image detection on the first image, and determining an image area that comprises the image location at which the fixation point is located as the target area; and
performing image segmentation on the target area to obtain the target area image.

10. The method according to claim 6, wherein after the receiving an image processing result sent by the mobile terminal, the method further comprises:
generating a voice instruction based on the image processing result, and playing the voice instruction;
and/or
displaying the image processing result on a display apparatus of the smart glasses.

11-13. (canceled)

14. A non-transitory computer-readable storage medium storing instructions, wherein the non-transitory computer-readable storage medium stores a computer program, which when executed by a processor causes the processor to:
in response to detecting that an eye movement type of a user is non-saccade, obtain a first image in a field of view of the user and a fixation point of a user eye;
determine a target area on the first image based on the fixation point, and segment the target area to obtain a target area image;
perform downsampling processing on the first image to obtain a second image; and
send the target area image and the second image to a mobile terminal bound and connected to the smart glasses, and receive an image processing result sent by the mobile terminal.

15. The non-transitory computer-readable storage medium according to claim 14, wherein the eye movement type comprises saccade and non-saccade, and the processor being caused to detect the eye movement type of the user comprises being caused to:
capture an eye movement parameter of the user eye through an eye tracking apparatus, wherein the eye movement parameter represents an eye movement speed of the user eye; and
when the eye movement parameter is greater than or equal to a preset threshold, determine that the eye movement type is saccade; or
when the eye movement parameter is less than a preset threshold, determine that the eye movement type is non-saccade.

16. The non-transitory computer-readable storage medium according to claim 14, wherein the processor being caused to obtain the fixation point of the user eye comprises being caused to:
emit an infrared light source to the user eye through a light source component of an eye tracking apparatus, and obtain a spot image of the user eye captured by an infrared camera of the eye tracking apparatus, wherein the spot image comprises a spot formed on the user eye by the infrared light source emitted by the light source component;
perform image detection on the spot image to determine a relative location between a pupil center of the user eye and the spot; and
determine the fixation point of the user eye based on the relative location and a pre-calibrated spot location.

17. The non-transitory computer-readable storage medium according to claim 14, wherein the processor being caused to determine a target area on the first image based on the fixation point, and segment the target area to obtain a target area image comprises being caused to:
determine an image location of the fixation point on the first image based on a pre-calibrated mapping relationship, wherein the mapping relationship represents a mapping relationship between a coordinate system in which the fixation point is located and an image coordinate system of the first image;
perform image detection on the first image, and determine an image area that comprises the image location at which the fixation point is located as the target area; and
perform image segmentation on the target area to obtain the target area image.

18. The non-transitory computer-readable storage medium according to claim 14, wherein after the processor being caused to receive an image processing result sent by the mobile terminal, the processor is further caused to:
generate a voice instruction based on the image processing result, and play the voice instruction;
and/or
display the image processing result on a display apparatus of the smart glasses.
